(19) United States
(12) Patent Application Publication
(10) Pub. No.: US 2015/0290783 A1
(43) Pub. Date: Oct. 15, 2015

(54) WRENCH TOOL WITH POSITIONING DEVICE

(71) Applicant: KAI-CHENG LIU, Taichung (TW)

(72) Inventor: KAI-CHENG LIU, Taichung (TW)

(21) Appl. No.: 14/540,402

(22) Filed: Nov. 13, 2014

(30) Foreign Application Priority Data
Apr. 11, 2014 (TW) 103113456

(51) Int. Cl. B25B 23/00

(52) U.S. Cl. CPC B25B 23/0035

(57) ABSTRACT

A wrench tool with a positioning device contains: a body, a toothed holder, and a positioning device. The body includes a first face, a second face, and an accommodating cavity defined in at least one end thereof. The toothed holder is accommodated in the accommodating cavity and has a polygonal groove, a first circular portion, and a second circular portion, the first circular portion is inserted to the first face, and the second circular portion is located on the second face. The positioning device includes a large-diameter slot, a small-diameter slot, and a flexible retaining ring, wherein when the retaining ring is located in small-diameter slot, it extends out of the polygonal through groove. The positioning device also includes at least one cutout defined on the second circular portion and communicating with the small-diameter slot, a pushing piece fitted with the second circular portion and pushing the retaining ring.

### FIELD OF THE INVENTION

The present invention relates to a wrench tool with a positioning device which fits with an operating tool securely and replaces the wrench tool easily.

### BACKGROUND OF THE INVENTION

Referring to FIGS. 1 and 2, a conventional socket wrench 10 contains a toothed holder 11 accommodated on one end thereof, and the toothed holder 11 includes a polygonal groove 111 defined therein, the polygonal groove 11 of the toothed holder 11 has a slot 112 arranged therein to retain a C-ring 12. Furthermore, a socket tool 20 has a hexagonal fitting segment 201, and the hexagonal fitting segment 201 has a plurality of notches 202 formed on plural corners thereof, such that when the hexagonal fitting segment 201 of the socket tool 20 fits with the polygonal groove 111 of the toothed holder 11, the C-ring 12 retains with the plurality of notches 202 of the socket tool 20, thus avoiding the socket tool 20 removing from the polygonal groove 111 of the toothed holder 11.

However, the C-ring 12 cannot retain with the plurality of notches 202 of the socket tool 20 fixedly, and the socket tool 20 removes from the socket wrench 10 easily.

The present invention has arisen to mitigate and/or obviate the afore-described disadvantages.

### SUMMARY OF THE INVENTION

The primary objective of the present invention is to provide a wrench tool with a positioning device which contains a large-diameter slot defined around an inner wall of a groove of a toothed holder, a small-diameter slot formed below the large-diameter slot, a flexible retaining ring accommodated in the large-diameter slot and the small-diameter slot, and at least one cutout defined on a second circular portion of the toothed holder and communicating with the small-diameter slot, such that the retaining ring partially extends out the second circular portion of the toothed holder; the positioning device also includes a pushing piece fitted with the second circular portion of the toothed holder and pushing the retaining ring; such that when the retaining ring is located in small-diameter slot, it extends out of the groove to clamp an operating tool securely.

Another objective of the present invention is to provide a wrench tool with a positioning device which contains the large-diameter slot defined around the inner wall of the groove of the toothed holder, the small-diameter slot formed below the large-diameter slot, the flexible retaining ring accommodated in the large-diameter slot and the small-diameter slot, the at least one cutout defined on the second circular portion of the toothed holder and communicating with the small-diameter slot, such that the retaining ring partially extends out the second circular portion of the toothed holder; the positioning device also includes the pushing piece fitted with the second circular portion of the toothed holder and pushing the retaining ring; such that when the toothed holder is pressed downwardly to drive the pushing piece, the pushing piece pushes the retaining ring to correspond to the large-diameter slot, the retaining ring move out of the groove to disengage from the operating tool, thus replacing the operating tool easily.

### BRIEF DESCRIPTION OF THE DRAWINGS

FIG. 1 is a perspective view of a conventional socket wrench and a socket tool.

FIG. 2 is a cross sectional view showing the operation of the conventional socket wrench and the socket tool.

FIG. 3 is a perspective view showing the exploded components of a socket wrench with a positioning device according to a first embodiment of the present invention.

FIG. 4 is a perspective view showing the assembly of a part of the socket wrench with the positioning device according to the first embodiment of the present invention.

FIG. 5 is a cross-sectional perspective view showing the assembly of a part of the socket wrench with the positioning device according to the first embodiment of the present invention.

FIG. 6-1 is a cross sectional view taken along lines A-A of FIG. 5.

FIG. 6-2 is a cross sectional view taken along lines B-B of FIG. 5.

FIG. 7 is a cross sectional view showing the operation of the socket wrench with the positioning device according to the first embodiment of the present invention.

FIG. 8 is also another cross sectional view showing the operation of the socket wrench with the positioning device according to the first embodiment of the present invention.

FIG. 9 is still another cross sectional view showing the operation of the socket wrench with the positioning device according to the first embodiment of the present invention.

FIG. 10 is another cross sectional view showing the operation of the socket wrench with the positioning device according to the first embodiment of the present invention.

FIG. 11 is also another cross sectional view showing the operation of the socket wrench with the positioning device according to the first embodiment of the present invention.

FIG. 12 is another cross sectional view showing the operation of the socket wrench with the positioning device according to the first embodiment of the present invention.

FIG. 13 is another cross sectional view showing the operation of the socket wrench with the positioning device according to the first embodiment of the present invention.

FIG. 14 is another cross sectional view showing the operation of the socket wrench with the positioning device according to the first embodiment of the present invention.

FIG. 15 is a perspective view showing the exploded components of a nut wrench with a positioning device according to a second embodiment of the present invention.

FIG. 16 is a perspective view showing the assembly of a part of the nut wrench with the positioning device according to the second embodiment of the present invention.

FIG. 17 is a cross-sectional perspective view showing the assembly of a part of the nut wrench with the positioning device according to the second embodiment of the present invention.

FIG. 18-1 is a cross sectional view taken along lines A-A of FIG. 17.

FIG. 18-2 is a cross sectional view taken along lines B-B of FIG. 17.

FIG. 19 is a cross sectional view showing the operation of the nut wrench with the positioning device according to the second embodiment of the present invention.

FIG. 20 is also another cross sectional view showing the operation of the nut wrench with the positioning device according to the second embodiment of the present invention.

FIG. 21 is still another cross sectional view showing the operation of the nut wrench with the positioning device according to the second embodiment of the present invention.

FIG. 22 is another cross sectional view showing the operation of the nut wrench with the positioning device according to the second embodiment of the present invention.

FIG. 23 is also another cross sectional view showing the operation of the nut wrench with the positioning device according to the second embodiment of the present invention.

FIG. 24 is another cross sectional view showing the operation of the nut wrench with the positioning device according to the second embodiment of the present invention.

FIG. 25 is another cross sectional view showing the operation of the nut wrench with the positioning device according to the second embodiment of the present invention.

FIG. 26 is another cross sectional view showing the operation of the nut wrench with the positioning device according to the second embodiment of the present invention.

### DETAILED DESCRIPTION OF THE PREFERRED EMBODIMENTS

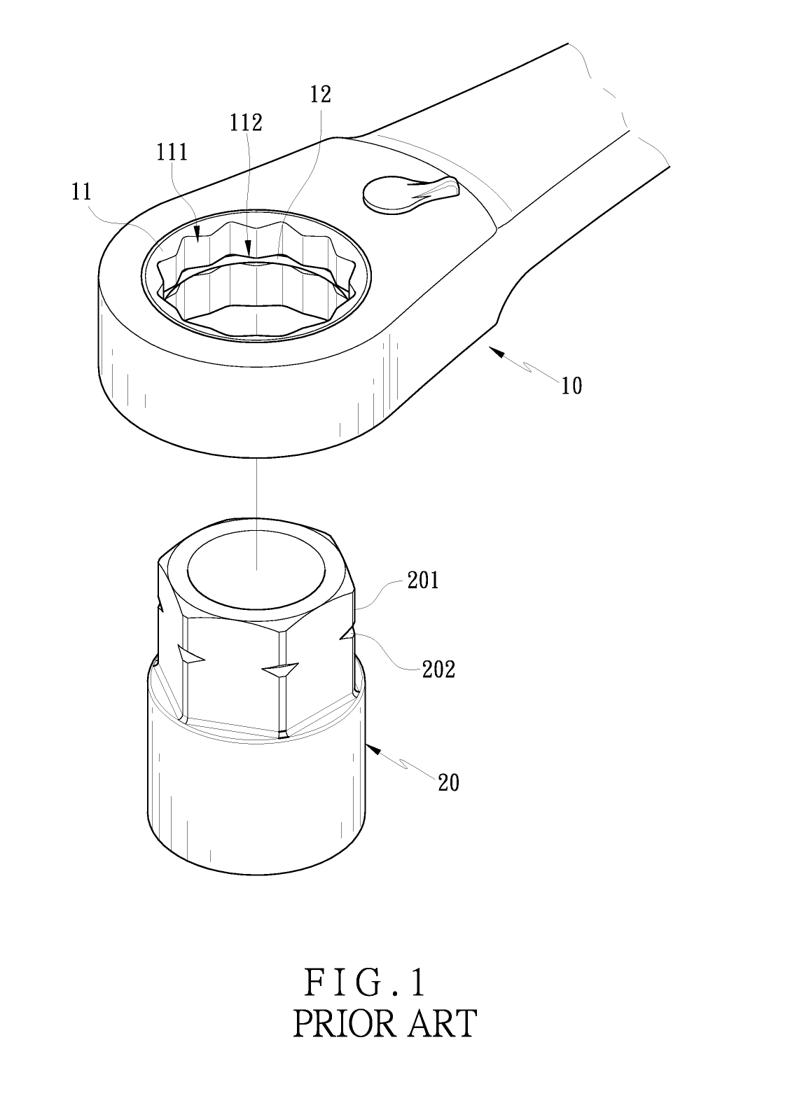

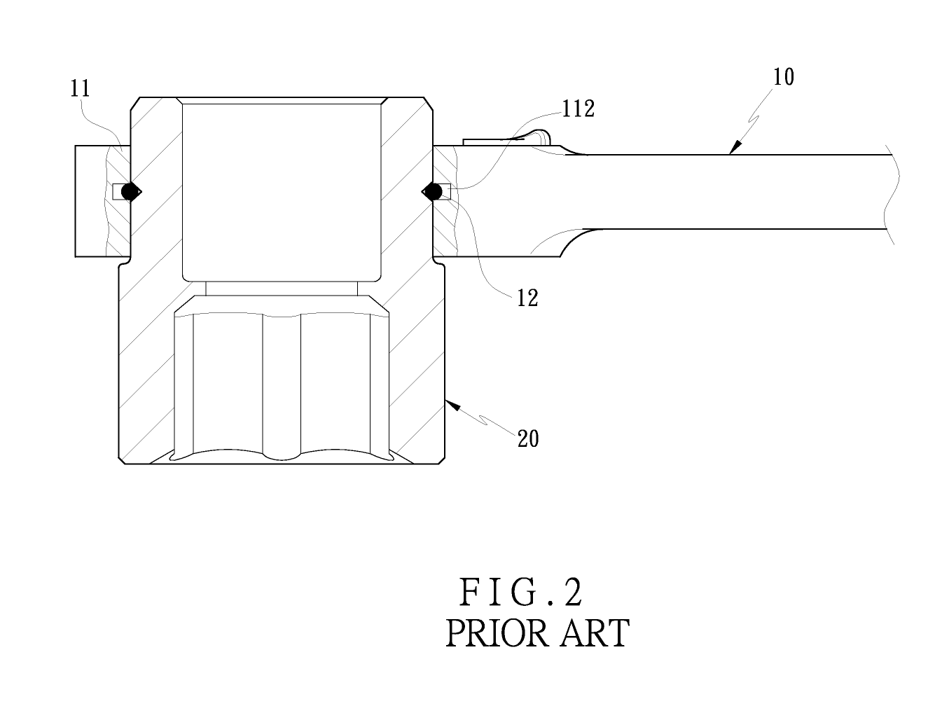

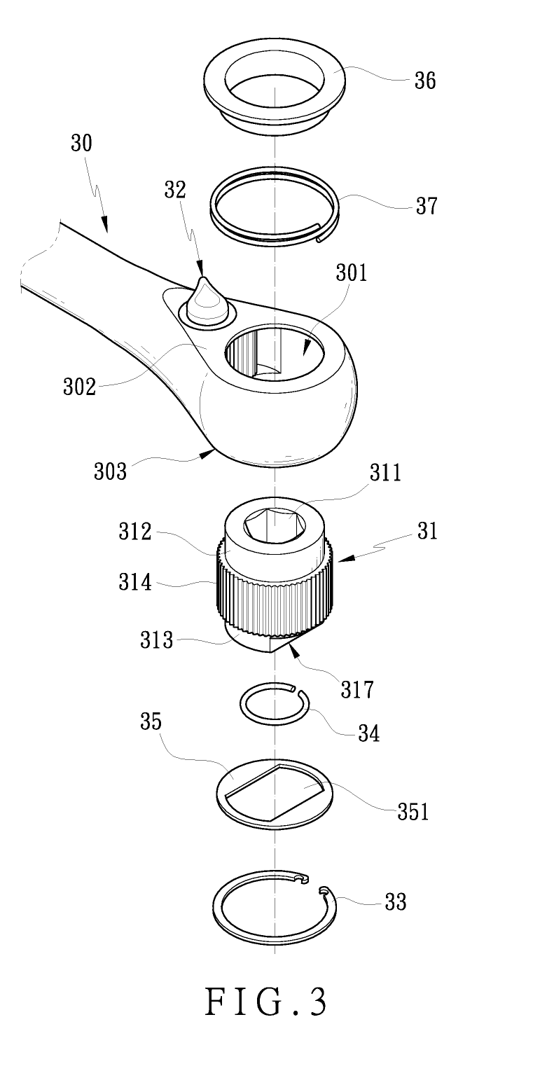

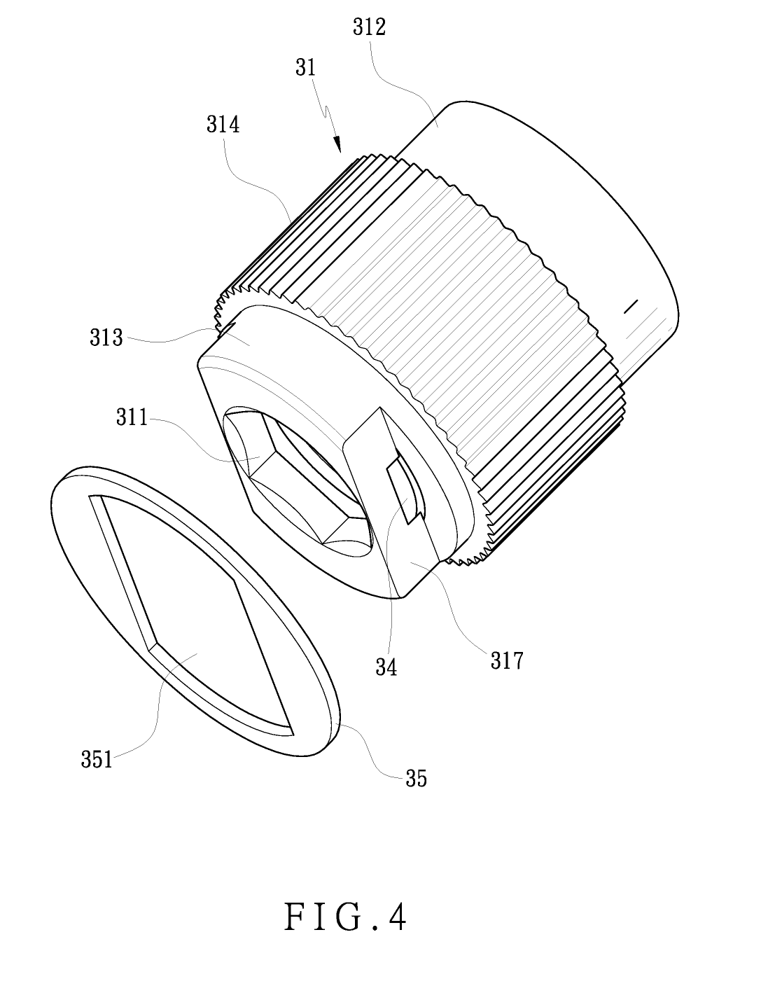

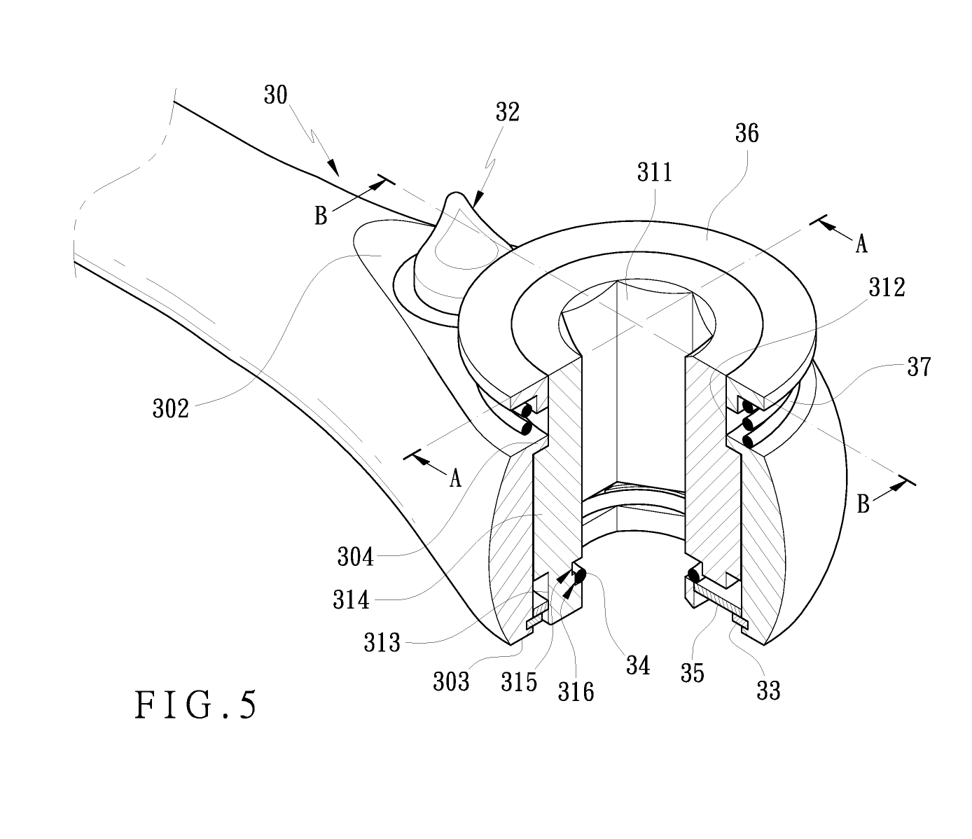

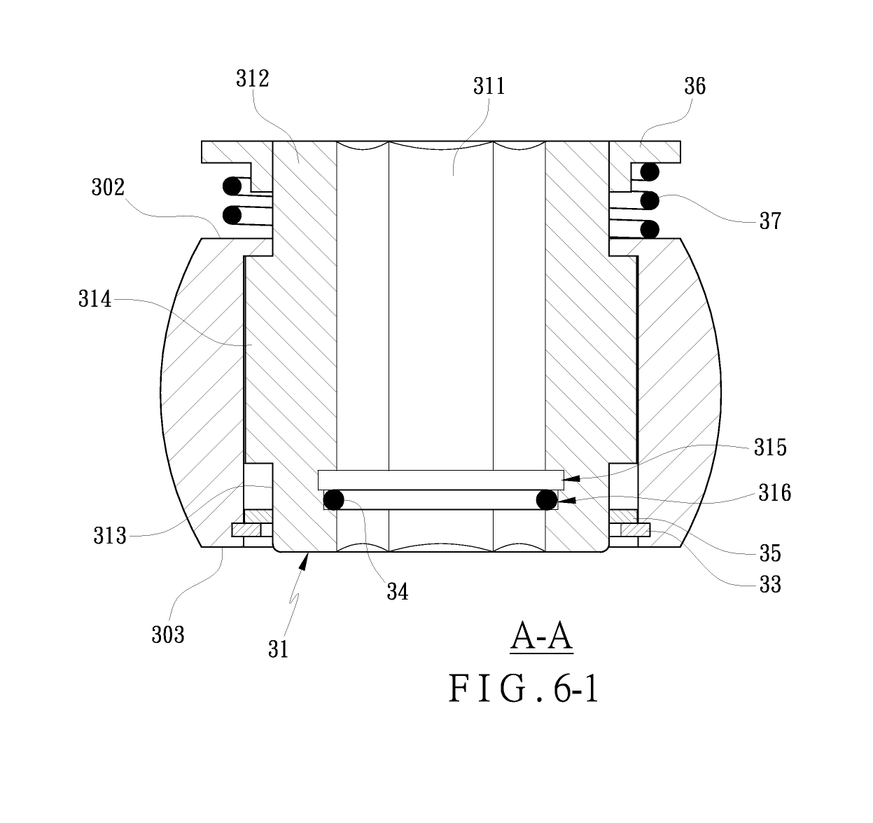

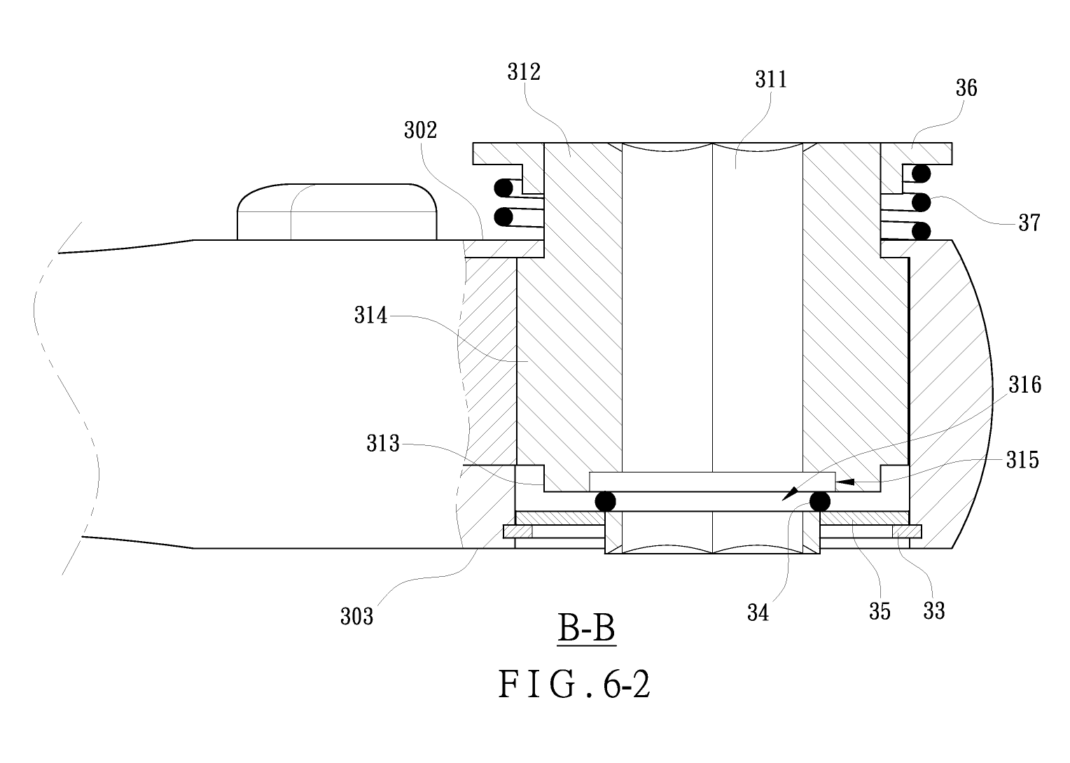

With reference to FIGS. 3-5, 6-1 and 6-2, a wrench tool according to a first embodiment of the present invention is a socket wrench and comprises: a body 30, and the body 30 includes an accommodating cavity 301 defined in at least one end thereof, a first face 302, and a second face 303. The accommodating cavity 301 has a first limiting element formed on the first face 302 or the second face 303 of the body 30. In this embodiment, the first limiting element is a stepped shoulder 304 formed on the first face 302 of the body 30. The accommodating cavity 301 has a toothed holder 31 accommodated therein, and the toothed holder 31 has a through groove 311 formed in a polygon shape therein to fit with an operating tool, a first circular portion 312 and a second circular portion 313 which are arranged around an outer peripheral side of the toothed holder 31, and a ratchet protrusion 314 defined between the first circular portion 312 and the second circular portion 313. The first circular portion 312 of the toothed holder 31 is inserted to the stepped shoulder 304 of the body 30, the second circular portion 313 of the toothed holder 31 is located on the second face 303 of the accommodating cavity 301, wherein an outer diameter of the ratchet protrusion 314 is larger than that of each of the first circular portion 312 and the second circular portion 313, such that a first end of the ratchet protrusion 314 is limited by the stepped shoulder 304, and the ratchet protrusion 314 engages with a ratchet device 32 on the body 30 adjacent to the accommodating cavity 301, hence the ratchet device 32 drives the toothed holder 31 to rotate in the accommodating cavity 301 of the body 30. Due to the ratchet device 32 is a well-known prior art, further remarks are omitted. A positioning device of the wrench tool according to the first embodiment of the present invention includes a large-diameter slot 315 defined around an inner wall of the through groove 311 of the toothed holder 31, a small-diameter slot 316 formed below the large-diameter slot 315, and a flexible retaining ring 34 accommodated in the large-diameter slot 315 and the small-diameter slot 316, wherein when the retaining ring 34 is located in small-diameter slot 316, it extends out of six corners of the through groove 311 to clamp the operating tool; the positioning device also includes at least one cutout 317 defined on the second circular portion 313 of the toothed holder 31 and communicating with the small-diameter slot 316, such that when the retaining ring 34 contacts with the small-diameter slot 316, it partially extends out of the cutout 317 of the second circular portion 313 (as shown in FIG. 4); the positioning device further includes a pushing piece 35, and the pushing piece 35 has a fitting orifice 351 defined thereon and corresponding to a profile of an end surface of the second circular portion 313, such that the pushing piece 35 is fitted with the second circular portion 313 of the toothed holder 31, pushes the retaining ring 34 of the second circular portion 313, and is limited by a second limiting element. In this embodiment, the second limiting element is a first C-ring 33. To maintain the retaining ring 34 of the toothed holder 31 in the small-diameter slot 316, the first circular portion 312 or the second circular portion 313 has a resilient element 37 fitted thereon, such that the toothed holder 31 is fixed above the accommodating cavity 301 to avoid the retaining ring 34 being pushed to the large-diameter slot 315 by the pushing piece 35. In this embodiment, the resilient element 37 is fitted on the first circular portion 312 of the toothed holder 31, and the first circular portion 312 has a circular pressing rib 36 arranged thereon, such that a first end of the resilient element 37 abuts against the circular pressing rib 36, and a second end of the resilient element 37 is biased against the first face 302 of the body 30. The circular pressing rib 36 presses the toothed holder 31 to move toward the second face 303 of the body 30, and when the circular pressing rib 36 presses the first circular portion 312 of the toothed holder 31, it presses the toothed holder 31 to move toward the second face 303 of the body 30.

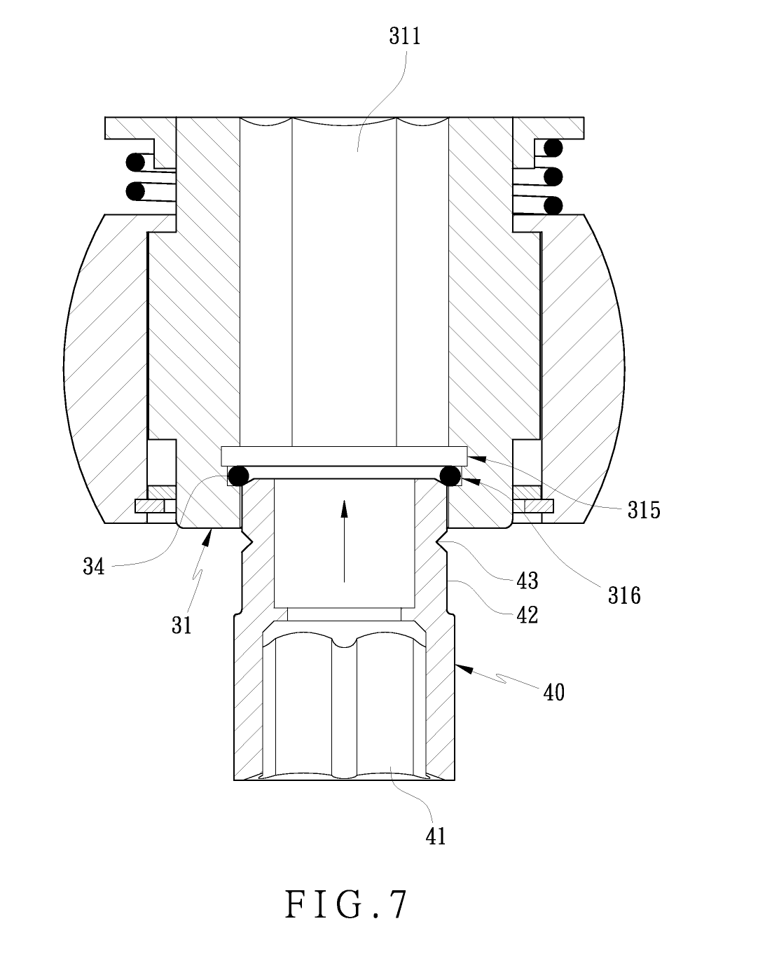

Referring to FIG. 7, the operating tool is a socket tool 40, and the socket tool 40 includes a working segment 41 and a fitting segment 42, wherein the working segment 41 is applied to fix or remove a bolt element, and the fitting segment 42 is hexagonal and is fitted in the through groove 311 of the toothed holder 31, wherein the fitting segment 42 has a notch 43 formed around at least one diagonal position thereof to match with the retaining ring 34. When the through groove 311 of the toothed holder 31 fits with the socket tool 40, since the retaining ring 34 retains in the small-diameter slot 316, it extends out of the six corners of the through groove 311.

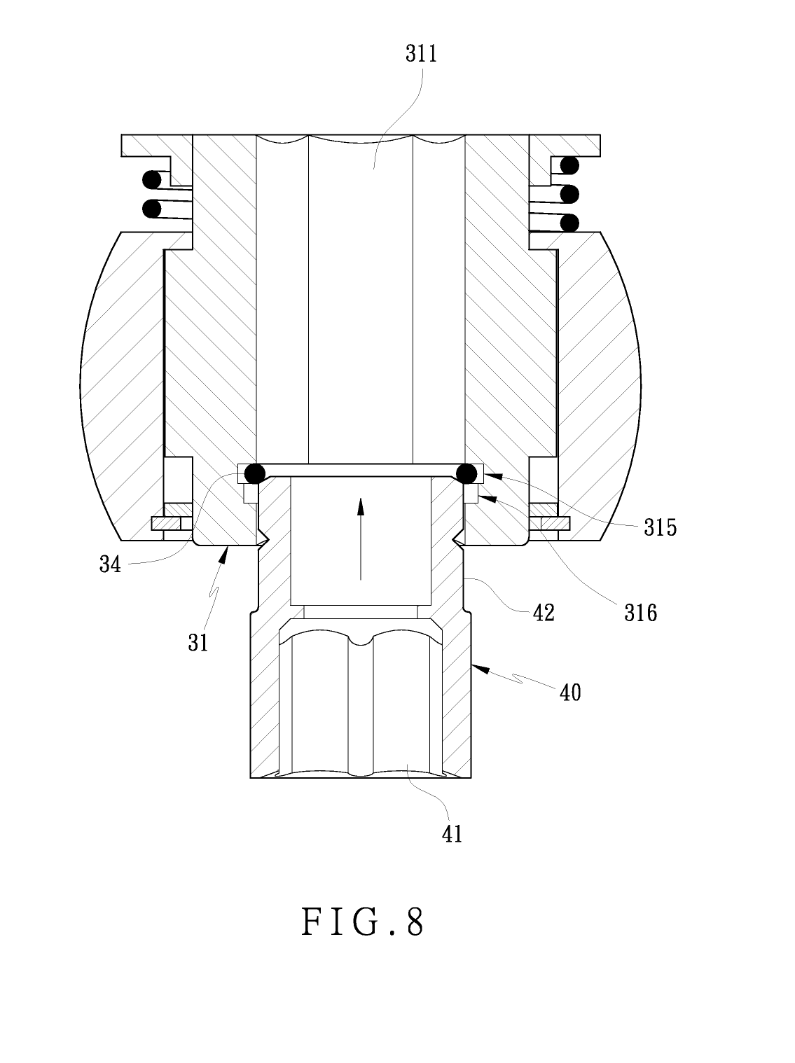

As shown in FIG. 8, because the retaining ring 34 extends out of the six corners of the through groove 311, six corners of the fitting segment 42 of the socket tool 40 pushes the retaining ring 34, and the retaining ring 34 does not expands outwardly, since it is limited by the small-diameter slot 316, such that the six corners of the fitting segment 42 of the socket tool 40 pushes the retaining ring 34 to move toward the large-diameter slot 315.

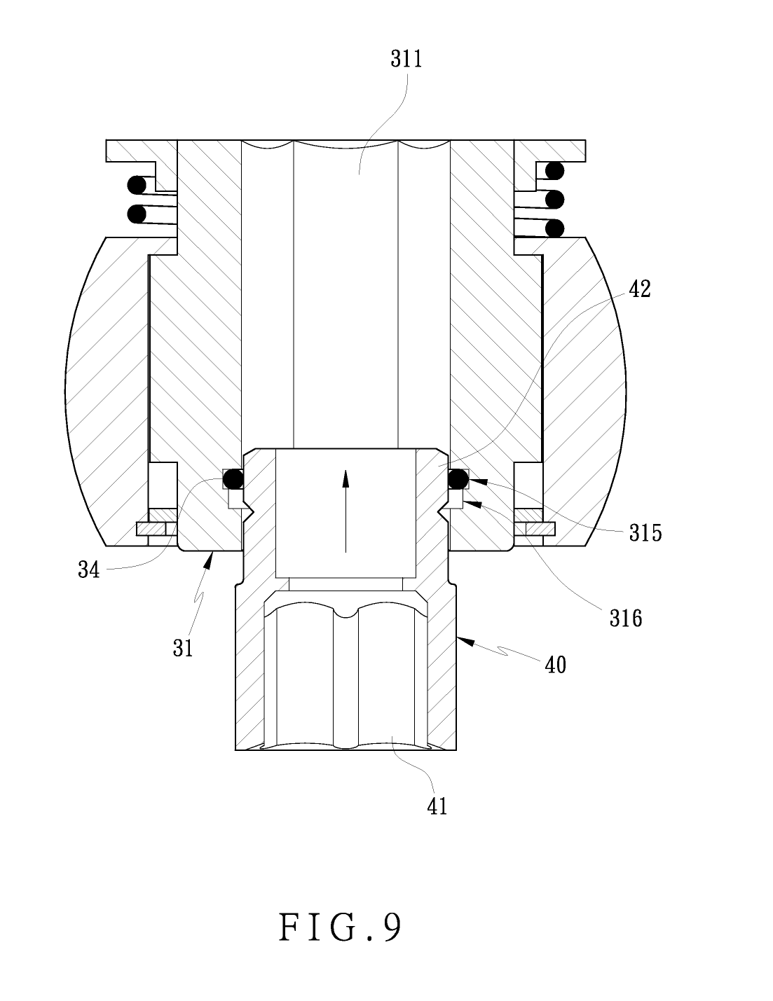

With reference to FIG. 9, after the retaining ring 34 moves toward the large-diameter slot 315, it pushes the socket tools 40, and the retaining ring 34 is pushed by the large-diameter slot 315, such that the fitting segment 42 of the socket tool 40 forces the retaining ring 34 to expand in the large-diameter slot 315 completely.

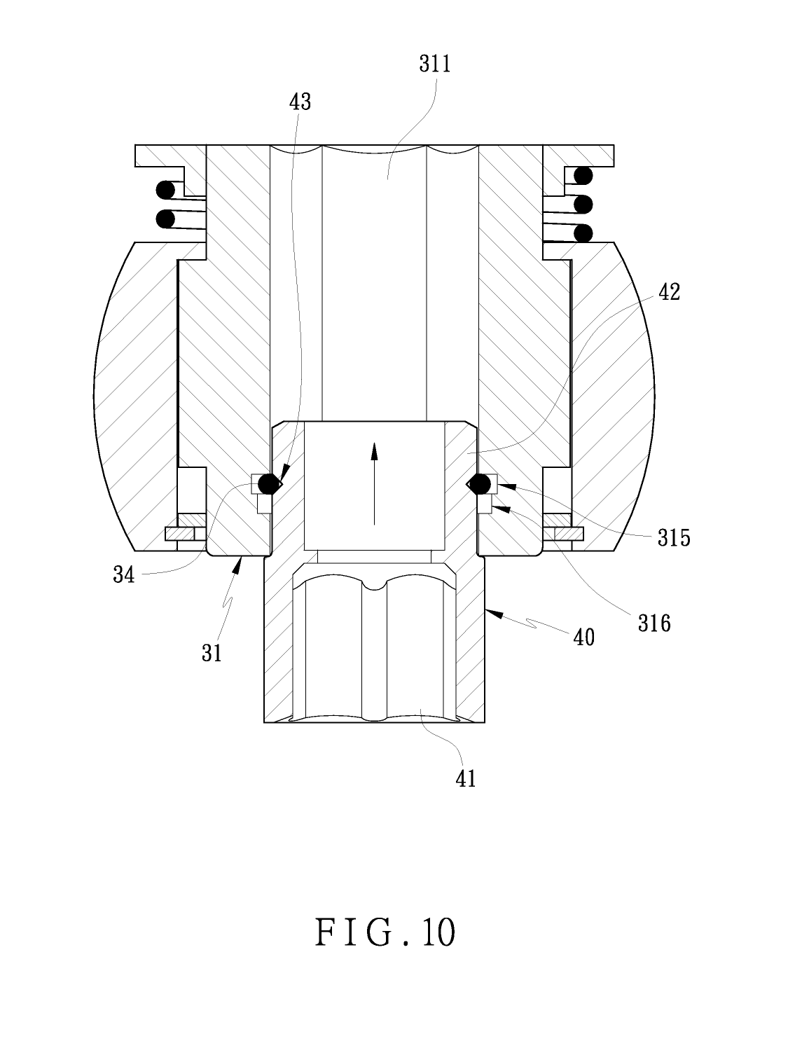

As illustrated in FIG. 10, when the fitting segment 42 of the socket tool 40 is pushed into the notch 43 to correspond to the retaining ring 34, the retaining ring 34 retains in the notch 43 of the socket tool 40, and the fitting segment 42 of the socket tool 40 is fitted in the through groove 311 of the toothed holder 31.

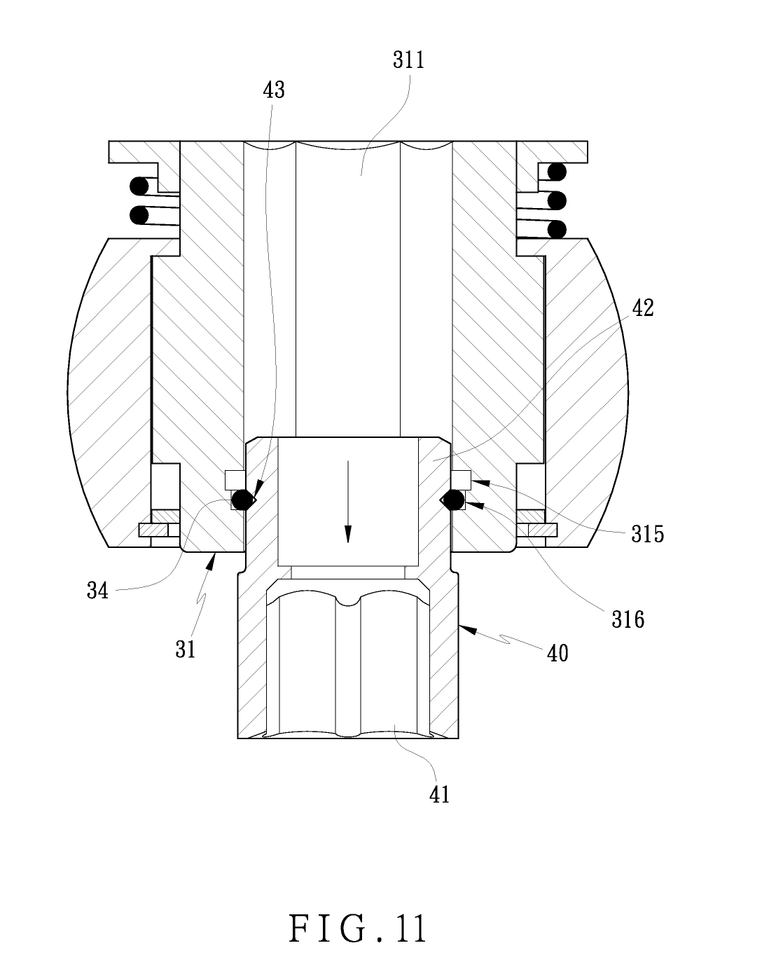

Referring to FIG. 11, when the fitting segment 42 of the socket tool 40 moves outwardly, the notch 43 of the socket tool 40 drives the retaining ring 34 to move into the small-diameter slot 316, and the small-diameter slot 316 limits an outward expansion of the retaining ring 34, such that the socket tool 40 does not move outwardly and is fitted with the toothed holder 31, thus avoiding a removal of the socket tool 40 from the toothed holder 31.

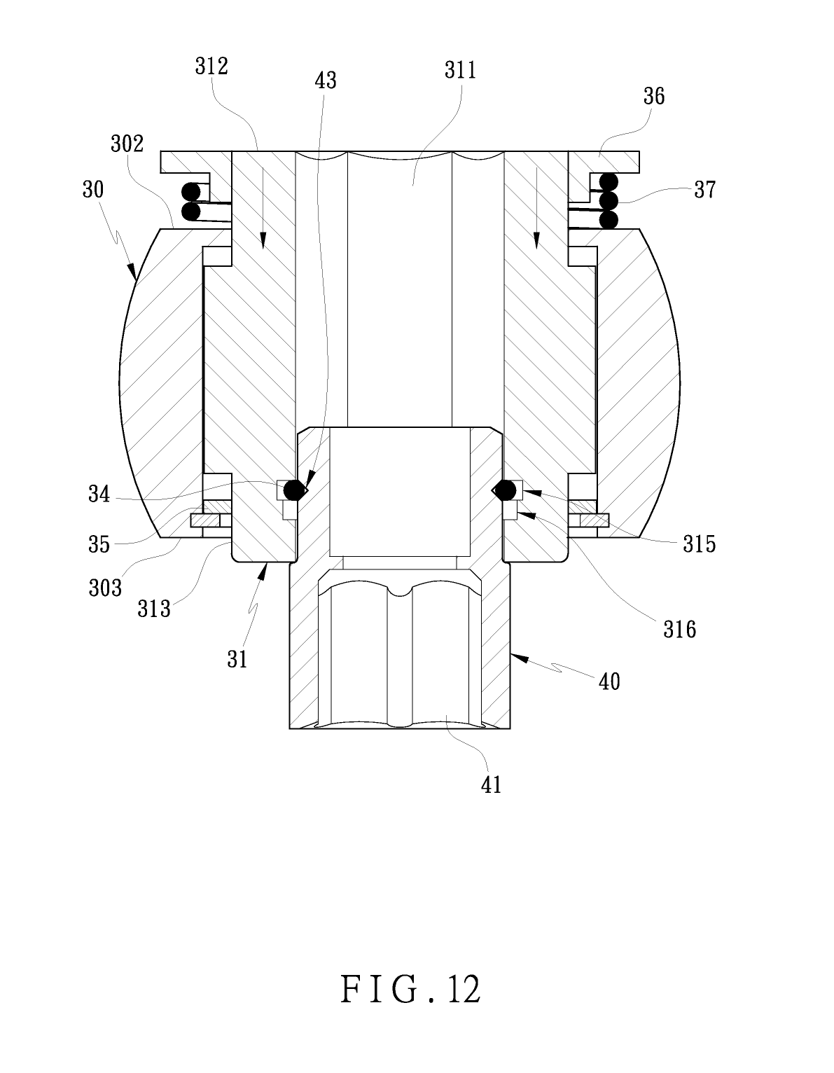

As illustrated in FIG. 12, as desiring to replace another socket tool 40 of a different size, the circular pressing rib 36 or the first circular portion 312 of the toothed holder 31 is pressed downwardly to press the resilient element 37, and the resilient element 37 pushes the toothed holder 31 to move toward the second face 303 of the body 30, in the meantime, the retaining ring 34 is pushed by the pushing piece 35 to correspond to the large-diameter slot 315.

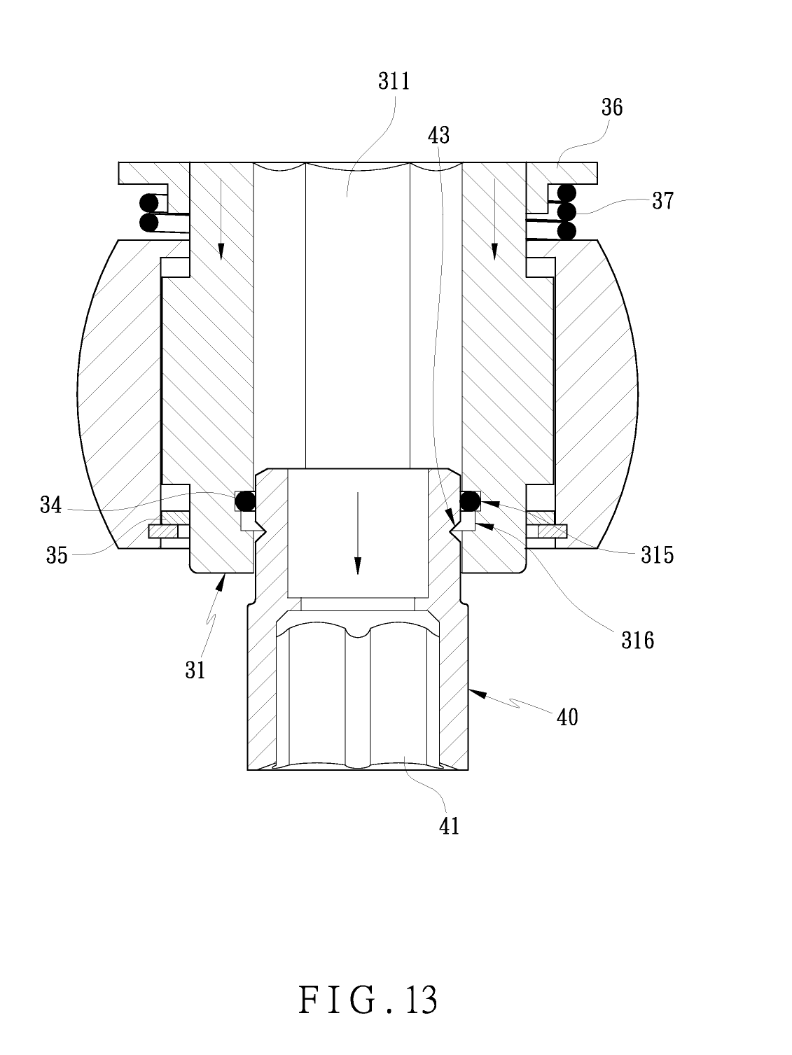

Referring to FIG. 13, when the socket tool 40 is pulled outwardly, the retaining ring 34 in the large-diameter slot 315 is pushed by the pushing piece 35 to locate in the large-diameter slot 315, and the notch 43 of the socket tool 40 forces the retaining ring 34 to expands outwardly, such that the notch 43 disengages from the retaining ring 34.

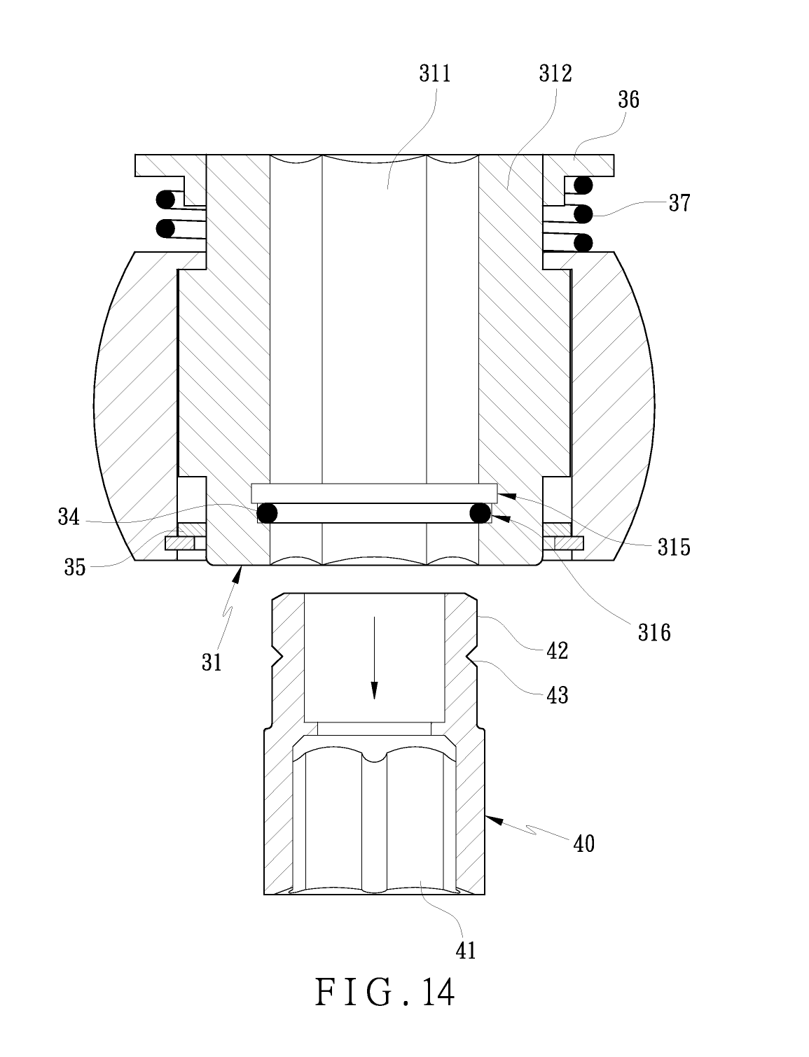

As shown in FIG. 14, after the notch 43 of the socket tool 40 disengages from the retaining ring 34, and the socket tool 40 is pulled continuously to remove from the toothed holder 31, such that another socket tool is fitted with the socket wrench. When releasing the circular pressing rib 36 or the first circular portion 312 of the toothed holder 31, the circular pressing rib 36 is pushed by the resilient element 37 to drive the toothed holder 31 to move back to an original position, thus replacing another socket tool.

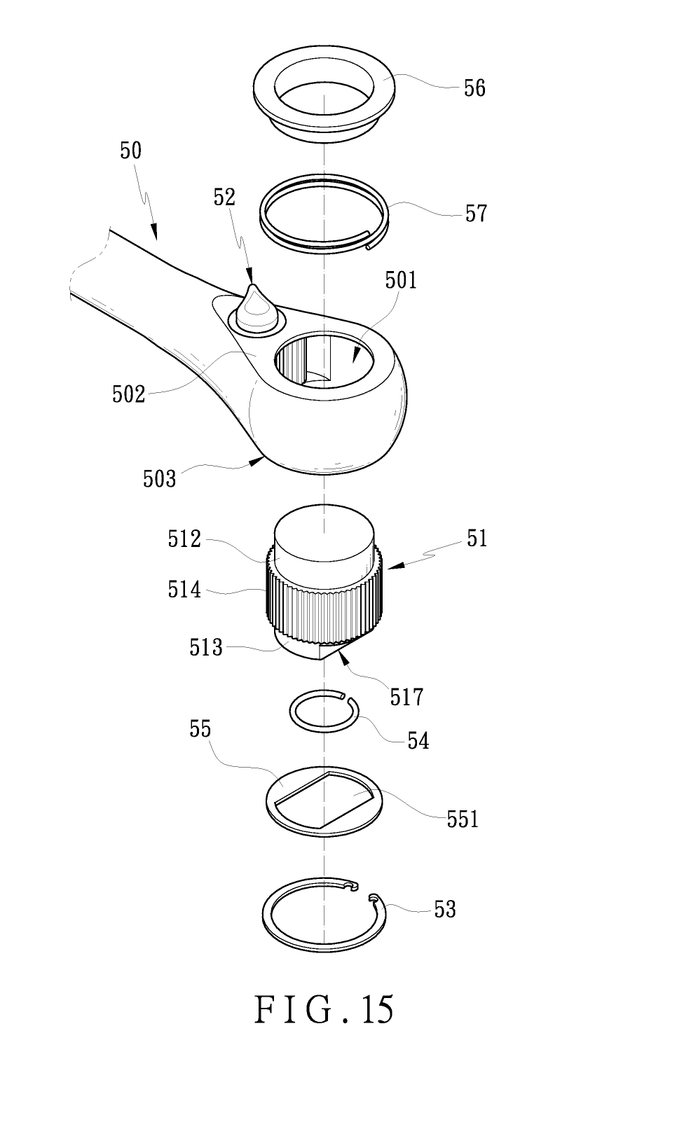

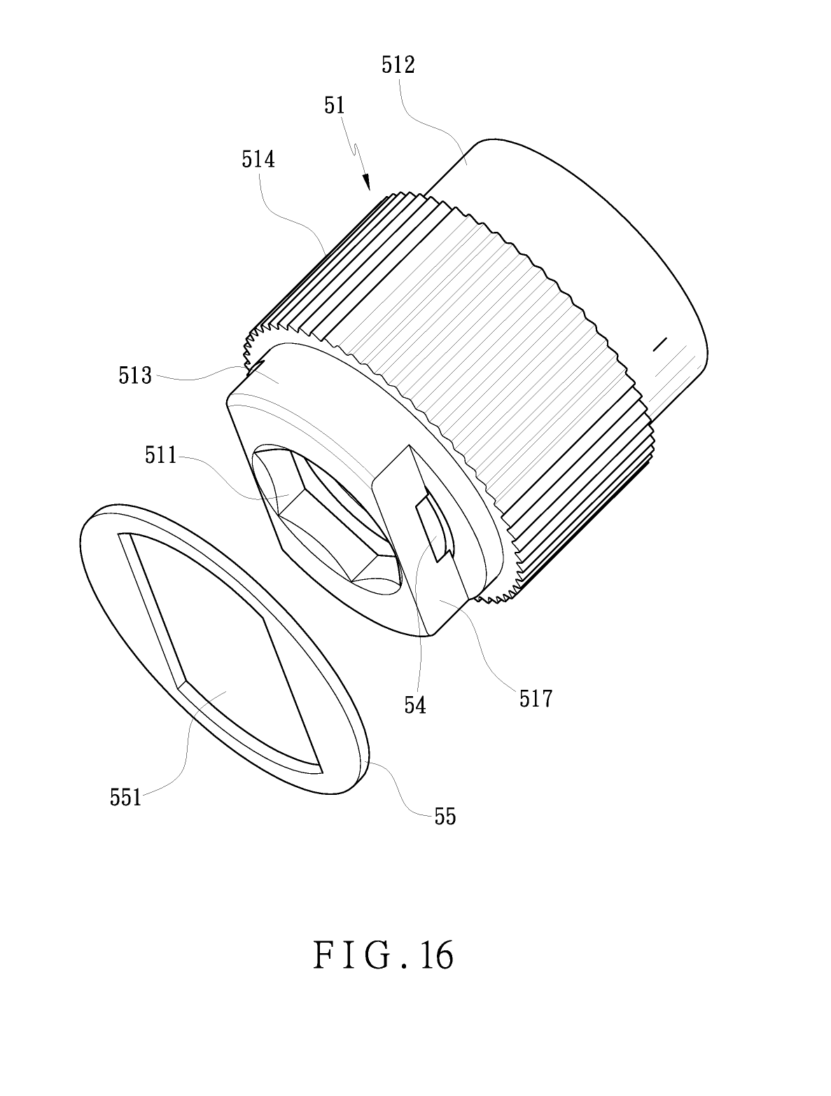

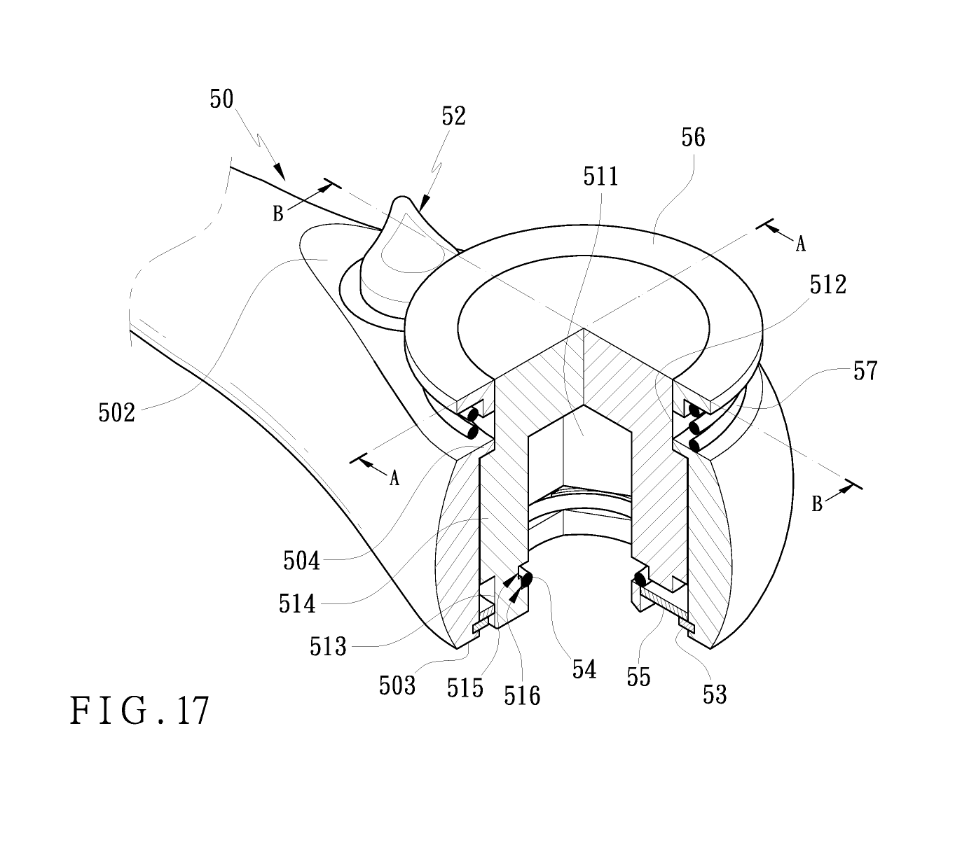

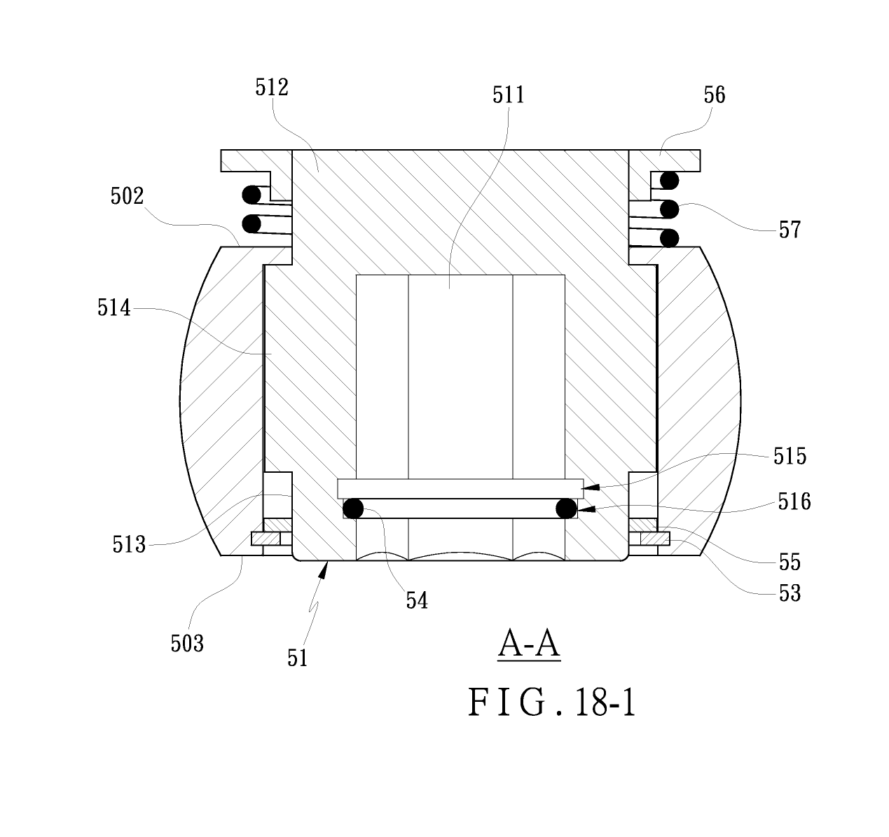

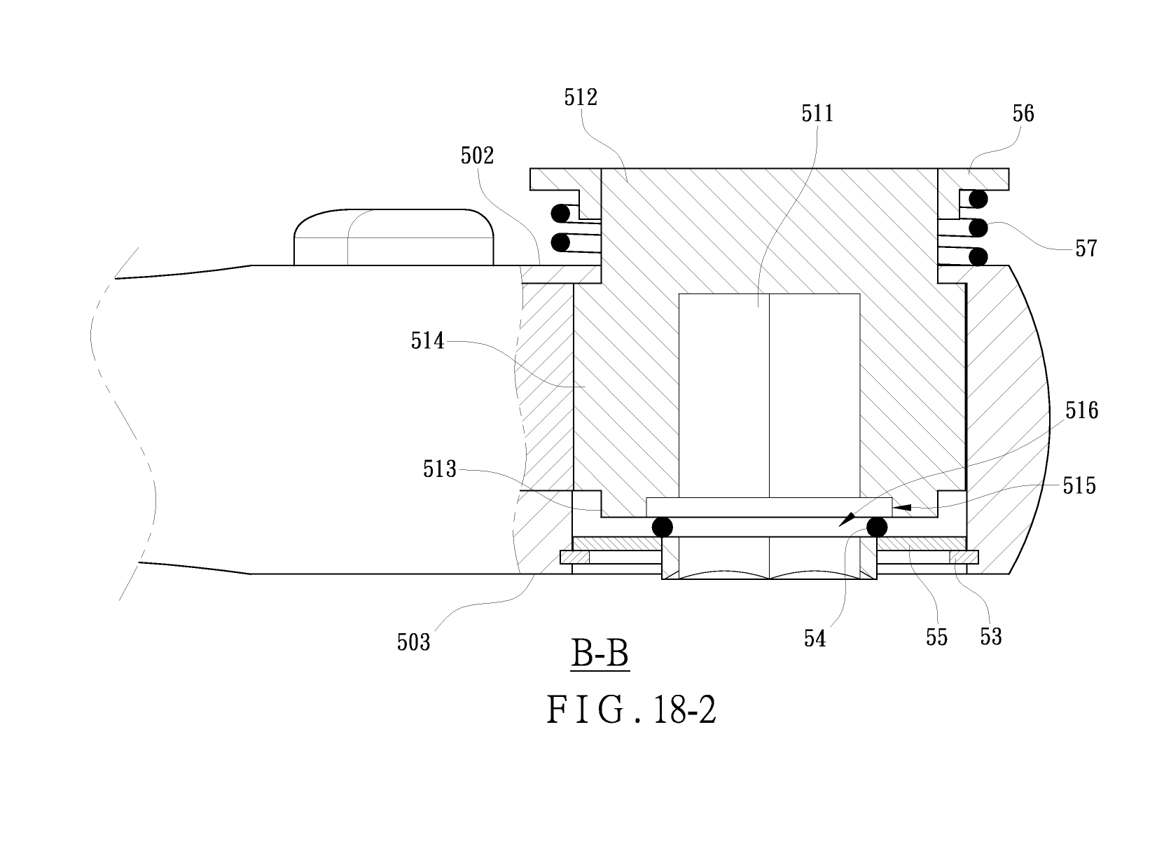

As shown in FIGS. 15-17, 18-1 and 18-2, a wrench tool according to a second embodiment of the present invention is a nut wrench and comprises: a body 50, and the body 50 includes an accommodating cavity 501 defined in at least one end thereof, a first face 502, and a second face 503. The accommodating cavity 501 has a first limiting element formed on the first face 502 or the second face 503 of the body 50. In this embodiment, the first limiting element is a stepped shoulder 504 formed on the first face 502 of the body 50. The accommodating cavity 501 has a toothed holder 51 accommodated therein, and the toothed holder 51 has a dead groove 511 formed in a polygon therein to fit with an operating tool, a first circular portion 512 and a second circular portion 513 which are arranged around an outer peripheral side of the toothed holder 51, and a ratchet protrusion 514 defined between the first circular portion 512 and the second circular portion 513. The first circular portion 512 of the toothed holder 51 is inserted to the stepped shoulder 504 of the body 50, the second circular portion 513 of the toothed holder 51 is inserted to the second face 503, wherein an outer diameter of the ratchet protrusion 514 is larger than that of each of the first circular portion 512 and the second circular portion 513, such that a first end of the ratchet protrusion 514 is limited by the stepped shoulder 504, and the ratchet protrusion 514 engages with a ratchet device 52 on the body 50 adjacent to the accommodating cavity 501, hence the ratchet device 52 drives the toothed holder 51 to rotate in the accommodating cavity 501 of the body 50. Due to the ratchet device 52 is a well-known prior art, further remarks are omitted. A positioning device of the wrench tool according to the second embodiment of the present invention includes a large-diameter slot 515 defined around an inner wall of the dead groove 511 of the toothed holder 51, a small-diameter slot 516 formed below the large-diameter slot 515, and a flexible retaining ring 54 accommodated in the large-diameter slot 515 and the small-diameter slot 516, wherein when the retaining ring 54 is located in small-diameter slot 516, it extends out of six corners of the through groove 511 to clamp the operating tool; the positioning device also includes at least one cutout 517 defined on the second circular portion 513 of the toothed holder 51 and communicating with the small-diameter slot 516, such that when the retaining ring 54 contacts with the small-diameter slot 516, it partially extends out of the cutout 517 of the second circular portion 513; the positioning further includes a pushing piece 55, and the pushing piece 55 has a fitting orifice 551 defined thereon and corresponding to a profile of an end surface of the second circular portion 513, such that the pushing piece 55 is fitted with the second circular portion 513 of the toothed holder 51, pushes the retaining ring 54 of the second circular portion 513, and is limited by a second limiting element. In this embodiment, the second limiting element is a first C-ring 53. To maintain the retaining ring 54 of the toothed holder 51 in the small-diameter slot 516, the first circular portion 512 or the second circular portion 513 has a resilient element 57 fitted thereon, such that the toothed holder 51 is fixed above the accommodating cavity 501 to avoid the retaining ring 54 being pushed to the large-diameter slot 515 by the pushing piece 55. In this embodiment, the resilient element 57 is fitted on the first circular portion 512 of the toothed holder 51, and the first circular portion 512 has a circular pressing rib 56 arranged thereon, such that a first end of the resilient element 57 abuts against the circular pressing rib 56, and a second end of the resilient element 57 is biased against the first face 502 of the body 50. The circular pressing rib 56 presses the toothed holder 51 to move toward the second face 503 of the body 50, and when the circular pressing rib 56 presses the first circular portion 512 of the toothed holder 51, it presses the toothed holder 51 to move toward the second face 503 of the body 50.

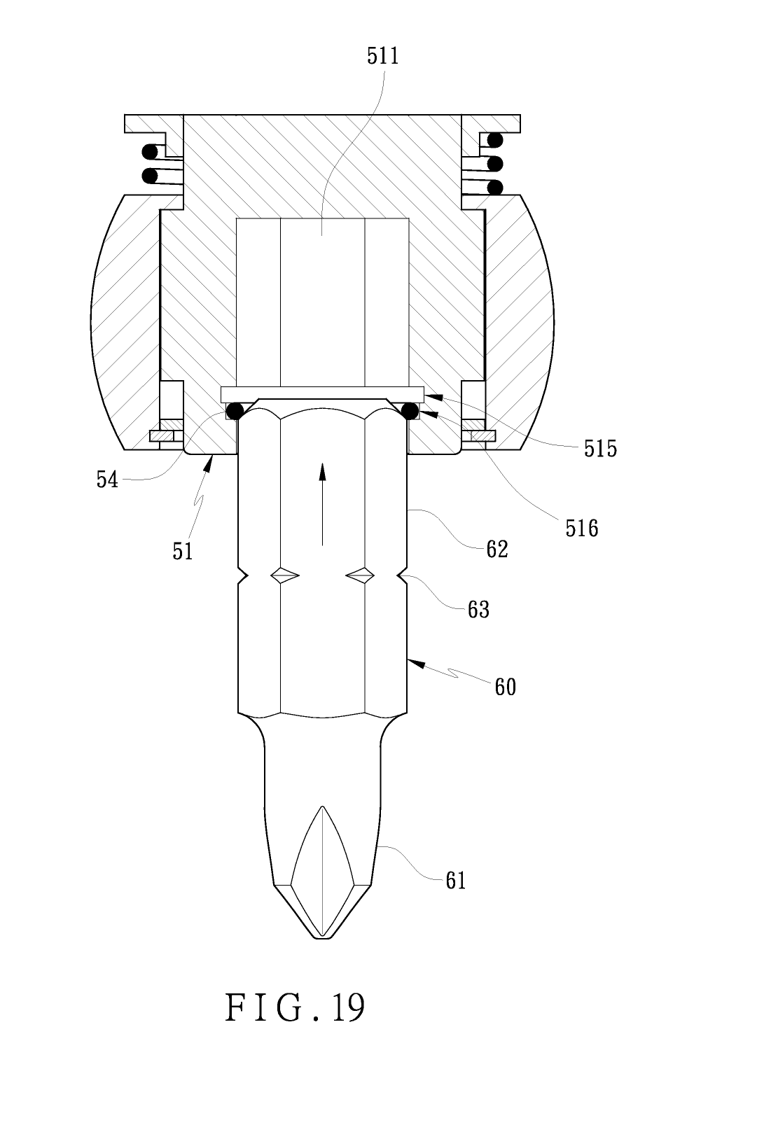

Referring to FIG. 19, the operating tool is a screwdriver bit 60, and the screwdriver bit 60 includes a working segment 61 and a fitting segment 62, wherein the working segment 61 is applied to fix or remove a bolt element, and the fitting segment 62 is hexagonal and is fitted in the dead groove 511 of the toothed holder 51, wherein the fitting segment 62 has a notch 63 formed around each of at least one diagonal position thereof to match with the retaining ring 54. When the dead groove 511 of the toothed holder 51 fits with the screwdriver bit 60, since the retaining ring 54 retains in the small-diameter slot 516, it extends out the six corners of the dead groove 511.

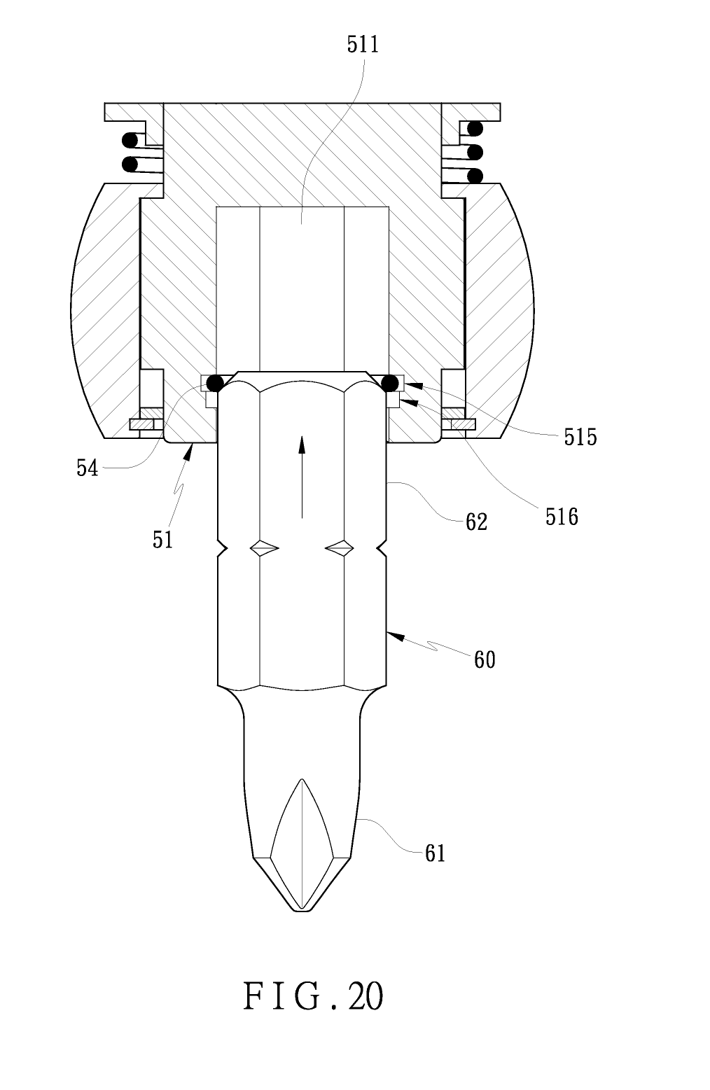

As shown in FIG. 20, because the retaining ring 54 extends out of the six corners of the dead groove 511, and six corners of the fitting segment 62 of the screwdriver bit 60 pushes the retaining ring 54, and the retaining ring 54 does not expands outwardly, since it is limited by the small-diameter slot 516, such that the six corners of the fitting segment 62 of the screwdriver bit 60 pushes the retaining ring 54 to move toward the large-diameter slot 515.

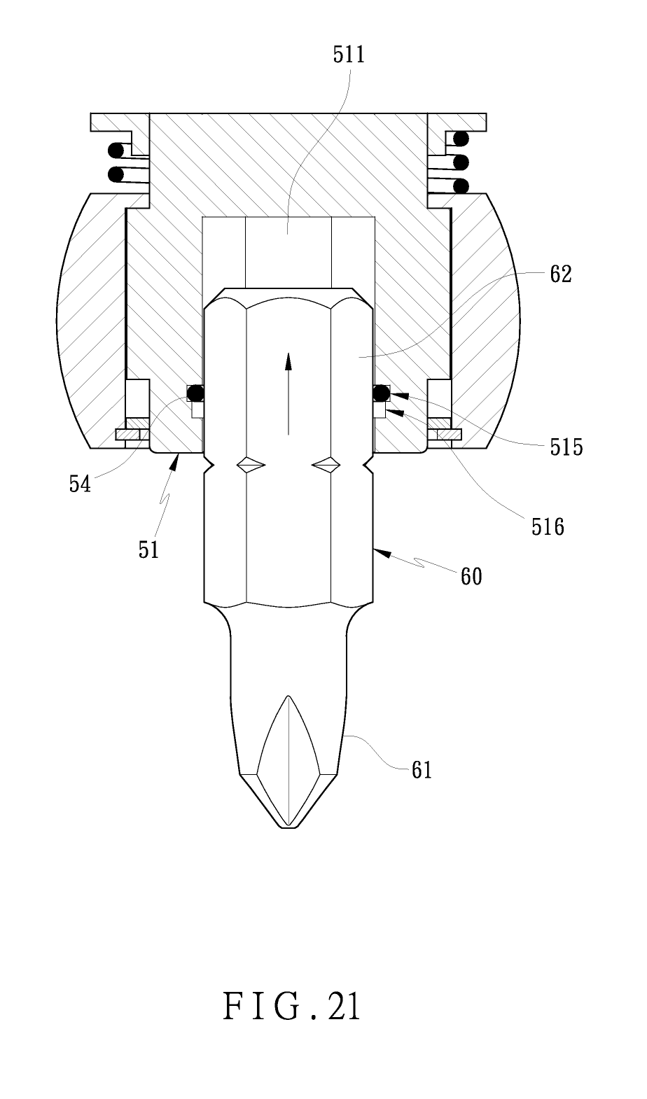

With reference to FIG. 21, after the retaining ring 54 moves toward the large-diameter slot 515, it pushes the screwdriver bit 60, and the retaining ring 54 is pushed by the large-diameter slot 515, such that the fitting segment 62 of the screwdriver bit 60 forces the retaining ring 54 to expand in the large-diameter slot 515 completely.

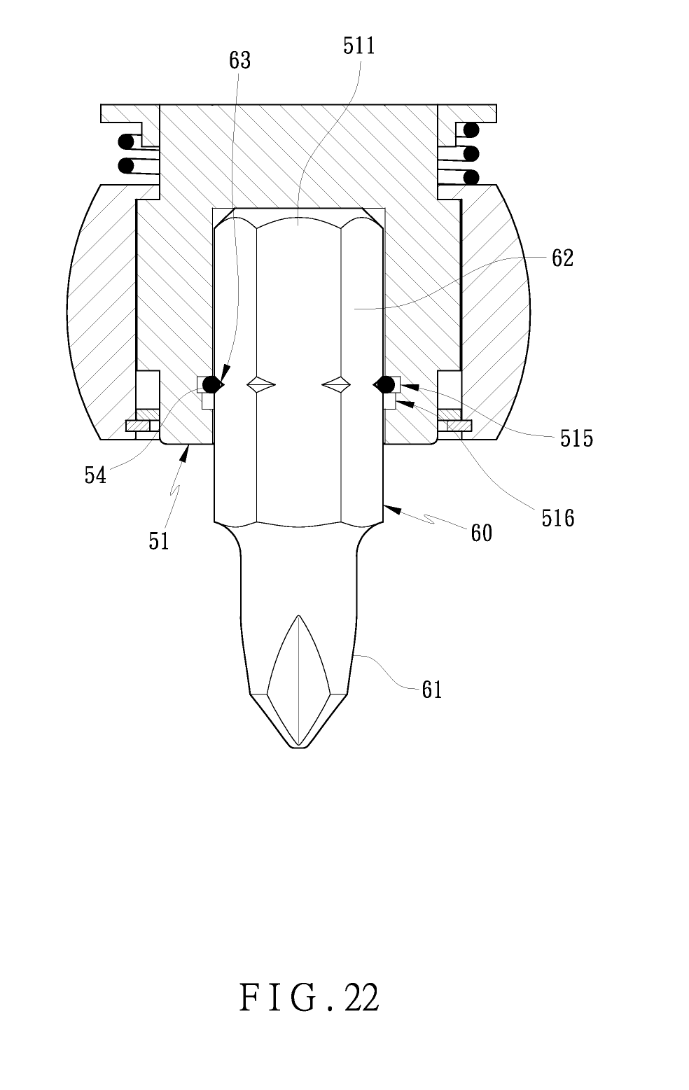

As illustrated in FIG. 22, when the fitting segment 62 of the screwdriver bit 60 is pushed into the notch 63 to correspond to the retaining ring 54, the retaining ring 54 retains in the notch 63 of the screwdriver bit 60, and the fitting segment 62 of the screwdriver bit 60 is limited in the dead groove 511.

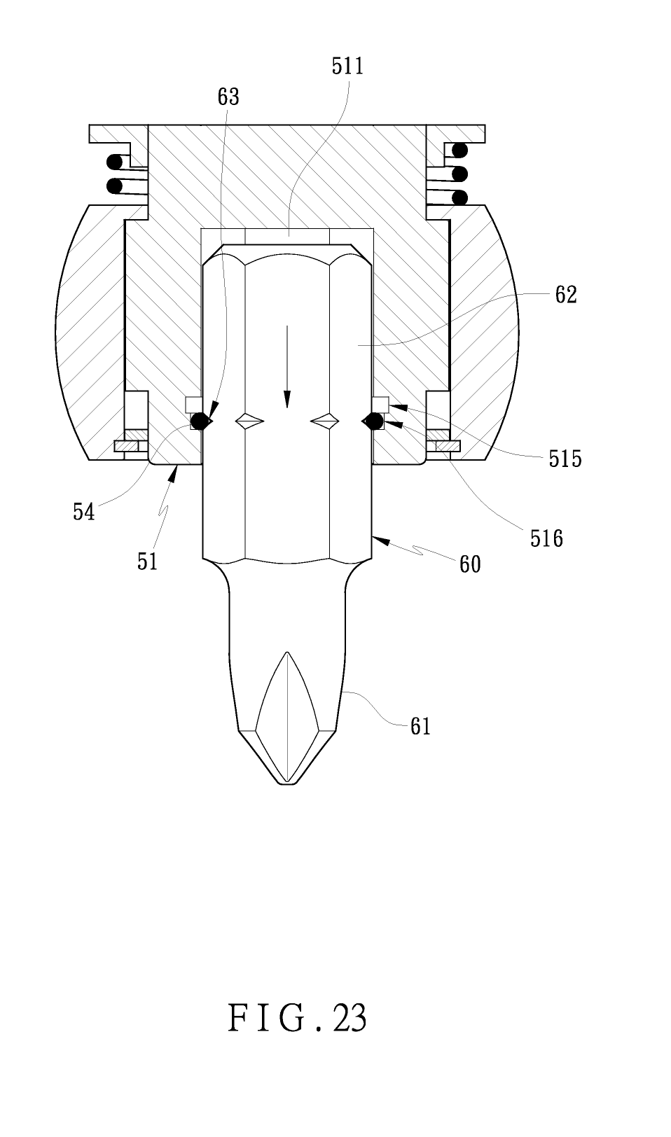

Referring to FIG. 23, when the fitting segment 62 of the screwdriver bit 60 moves outwardly, the notch 63 of the screwdriver bit 60 drives the retaining ring 54 to move into the small-diameter slot 516, and the small-diameter slot 516 limits an outward expansion of the retaining ring 54, such that the screwdriver bit 60 does not move outwardly and is fitted with the toothed holder 51, thus avoiding a removal of the screwdriver bit 60 from the toothed holder 51.

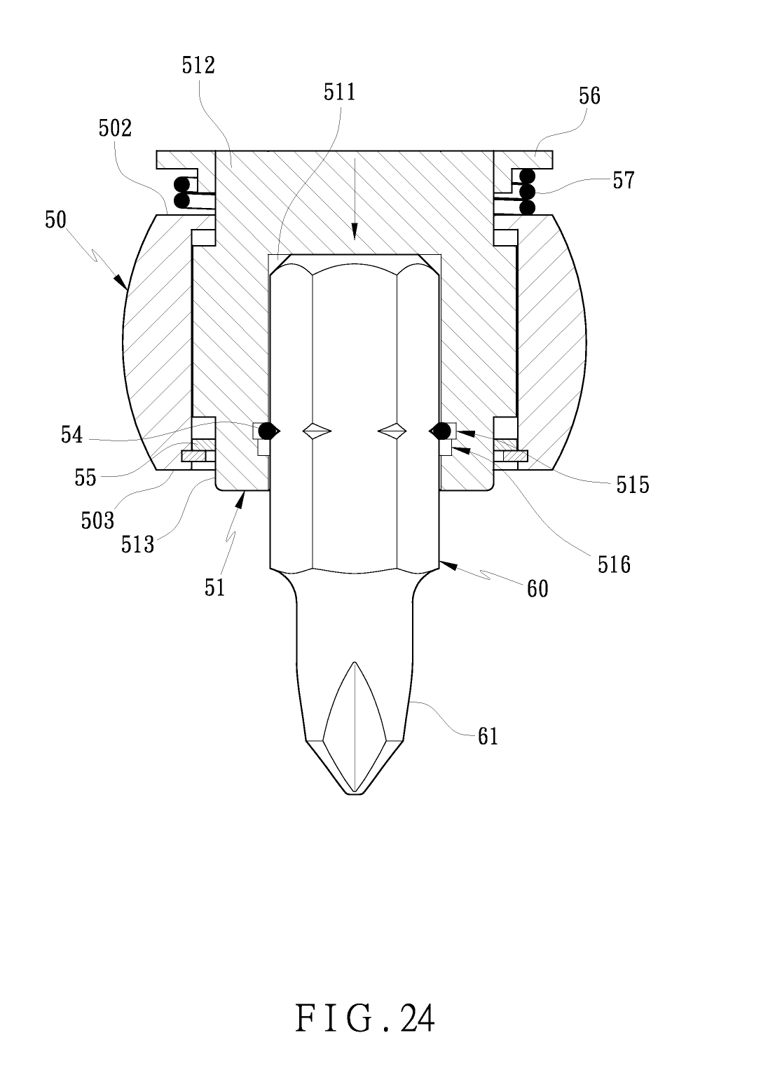

As illustrated in FIG. 24, as desiring to replace another screwdriver bit 60 of a different size, the circular pressing rib 56 or the first circular portion 512 of the toothed holder 51 is pressed downwardly to press the resilient element 57, and the resilient element 57 pushes the toothed holder 51 to move toward the second face 503 of the body 50, in the meantime, the retaining ring 54 of the second circular portion 513 is pushed by the pushing piece 55 to correspond to the large-diameter slot 515.

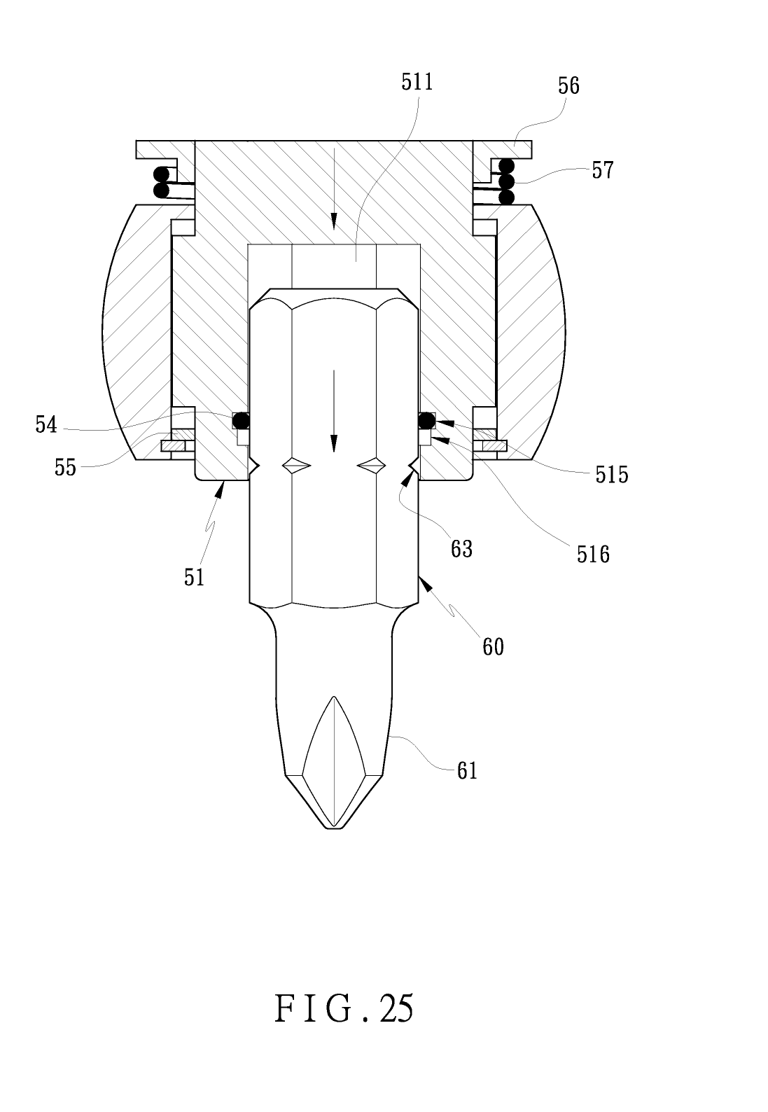

Referring to FIG. 25, when the screwdriver bit 60 is pulled outwardly, the retaining ring 54 in the large-diameter slot 515 is pushed by the pushing piece 55 to locate in the large-diameter slot 515, and the notch 63 of the screwdriver bit 60 forces the retaining ring 54 to expands outwardly, such that the notch 63 disengages from the retaining ring 54.

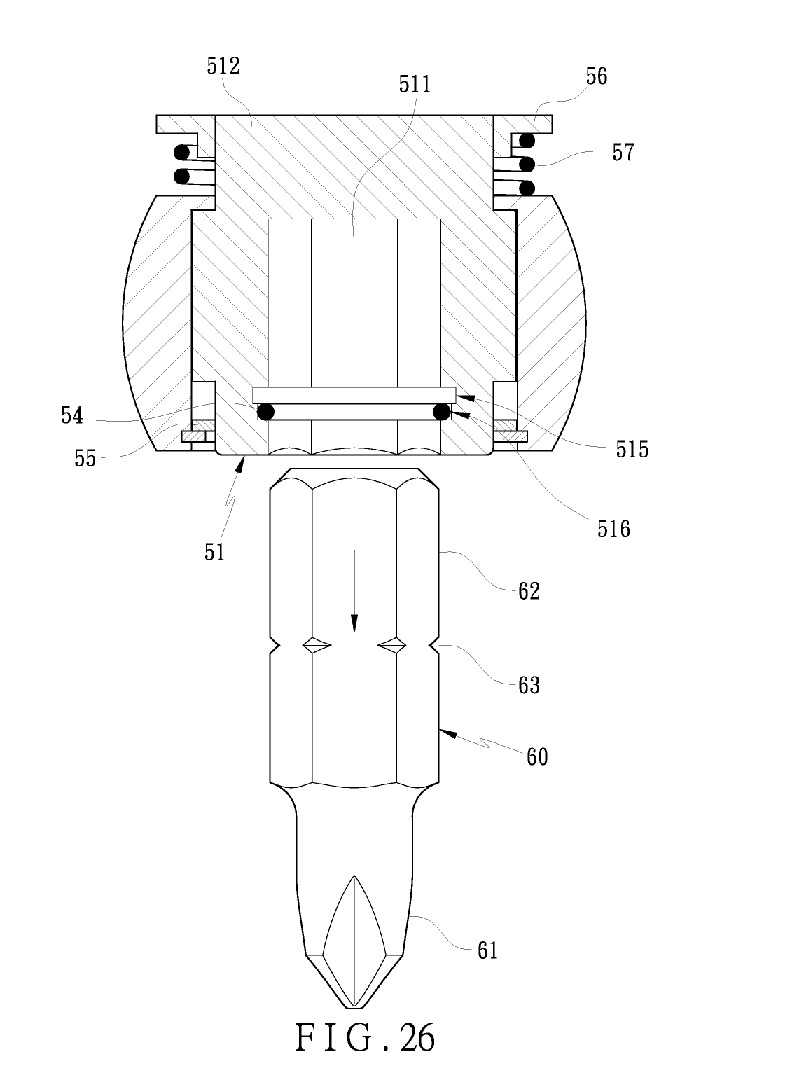

As shown in FIG. 26, after the notch 63 of the screwdriver bit 60 disengages from the retaining ring 54, and the screwdriver bit 60 is pulled continuously to remove from the toothed holder 51, such that another screwdriver bit is fitted with the nut wrench. When releasing the circular pressing rib 56 or the first circular portion 512 of the toothed holder 51, the circular pressing rib 56 is pushed by the resilient element 57 to drive the toothed holder 51 to move back to an original position, thus replacing another screwdriver bit.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A wrench tool with a positioning device comprising:
a body including a first face, a second face, and an accommodating cavity defined in at least one end thereof;
a toothed holder accommodated in the accommodating cavity of the body and having a groove defined therein, a first circular portion and a second circular portion which are arranged around an outer peripheral side of the toothed holder, the first circular portion being inserted to the first face of the body, and the second circular portion being located on the second face of the body;
a positioning device including a large-diameter slot defined around an inner wall of the groove of the toothed holder, a small-diameter slot formed below the large-diameter slot, and a flexible retaining ring accommodated in the large-diameter slot and the small-diameter slot, wherein when the retaining ring is located in small-diameter slot, it extends out of the groove; the positioning device also including at least one cutout defined on the second circular portion of the toothed holder and communicating with the small-diameter slot, a pushing piece fitted with the second circular portion of the toothed holder and pushing the retaining ring.

2. The wrench tool with the positioning device as claimed in claim 1, wherein the accommodating cavity of the body has a first limiting element formed on the first face, and the first limiting element is a stepped shoulder.

3. The wrench tool with the positioning device as claimed in claim 2, wherein the toothed holder also has a ratchet protrusion defined between the first circular portion and the second circular portion, a first end of the ratchet protrusion is limited by the stepped shoulder, and the first circular portion of the toothed holder is inserted to the stepped shoulder.

4. The wrench tool with the positioning device as claimed in claim 3, wherein the ratchet protrusion engages with a ratchet device on the body adjacent to the accommodating cavity, hence the ratchet device drives the toothed holder to rotate in the accommodating cavity of the body.

5. The wrench tool with the positioning device as claimed in claim 1, wherein the groove of the toothed holder is a through groove to fit with a socket tool which includes a fitting segment and a notch.

6. The wrench tool with the positioning device as claimed in claim 1, wherein the groove of the toothed holder is a dead groove to fit with a screwdriver bit which includes a fitting segment and a notch.

7. The wrench tool with the positioning device as claimed in claim 1, wherein the retaining ring extends out of six corners of the groove.

8. The wrench tool with the positioning device as claimed in claim 1, wherein the retaining ring partially extends out of the second circular portion, the pushing piece has a fitting orifice defined thereon and corresponding to a profile of an end surface of the second circular portion, such that the pushing piece pushes the retaining ring and is limited by a second limiting element.

9. The wrench tool with the positioning device as claimed in claim 1, wherein the first circular portion or the second circular portion has a resilient element fitted thereon, such that the toothed holder is fixed above the accommodating cavity by the resilient element, and the resilient element pushes the toothed holder to move toward the second face of the body.

10. The wrench tool with the positioning device as claimed in claim 9, wherein the resilient element is fitted on the first circular portion of the toothed holder, and the first circular portion has a circular pressing rib arranged thereon, such that a first end of the resilient element abuts against the circular pressing rib, and a second end of the resilient element is biased against the first face of the body.
